(19) United States
(12) Patent Application Publication
(10) Pub. No.: US 2008/0231550 A1
(43) Pub. Date: Sep. 25, 2008

(54) DISPLAY PANEL AND FABRICATION METHOD THEREOF

(75) Inventor: Yung-Chien Chen, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 11/829,060

(22) Filed: Jul. 26, 2007

(30) Foreign Application Priority Data
Mar. 22, 2007 (TW) 96109877

(51) Int. Cl. G09G 3/20

(52) U.S. Cl. 345/55

(57) ABSTRACT

A display panel including a substrate and a plurality of chips is provided. The substrate has a display region and a non-display region disposed on one side of the display region. The non-display region has a plurality of pad regions, and each pad region has a plurality of first pins and a plurality of alignment pins disposed therein. The chips are disposed in the non-display region. Each chip has a plurality of second pins. The second pins are connected to the first pins correspondingly.

### CROSS-REFERENCE TO RELATED APPLICATION

This application claims the priority benefit of Taiwan application serial no. 96109877, filed Mar. 22, 2007. All disclosure of the Taiwan application is incorporated herein by reference.

### BACKGROUND OF THE INVENTION

1. Field of the Invention

The present invention relates to a display panel, and more particularly, to a display panel and a fabrication method thereof adapted for easy fabrication yield monitor.

2. Description of Related Art

With superior display quality and low manufacturing costs, the cathode ray tube (CRT) displays have dominated the display market. However, the CRT displays are unfavorable because they produce hazardous radiation and are bulky. Recently, due to rapid advancement in semiconductor devices, planar displays having the advantages such as high image quality, good space utilization, low power consumption and non-radiation have become the mainstream products in the display market.

Components of a planar display include a display panel, a light source used for providing sufficient luminance to the display panel, and chips disposed on a substrate of the display panel. Further, the chips are utilized to drive internal circuits of the display panel so that the display panel can display images.

FIG. 1A is a schematic view illustrating a conventional display panel. FIG. 1B is an enlarged partial view of FIG. 1A. Please refer to FIG. 1A and FIG. 1B. A plurality of pad regions 120 is located in a non-display region 110a of a substrate 110 of a display panel 100, and there is a plurality of pins 122 disposed in each pad region 120. The pins 122 are connected to the pins 132 of a chip 130 correspondingly.

However, when the pins 132 of the chip are bonded to the pins 122 of the pad regions 120 by thermal compression, the shapes of the pins 122 may expand or the bonding may misalign according to the different locations the pins 122 are disposed in the pad regions 120 due to the characteristics of material used to fabricate the pins 122 and the pins 132. The aforementioned issues affect the bonding rate of the pins 122 of the pad regions 120 to the pins 132 of the chip 130. When the bonding rate of the pins 132 of the chip 130 to the pins 122 on the substrate 110 is low, the display quality of the display panel 100 is adversely affected.

### SUMMARY OF THE INVENTION

The present invention is directed to a display panel adapted for easy inspection of the bonding pins yield.

The present invention is directed to a method of fabricating a display panel that is adapted for easy fabrication yield control.

The present invention is directed to a display panel including a substrate and a plurality of chips. The substrate has a display region and a non-display region disposed on one side of the display region. A plurality of pad regions is located in the non-display region. Further, a plurality of first pins and a plurality of alignment pins are disposed in each pad region. The chips are disposed in the non-display region. Herein, each chip has a plurality of second pins and the second pins are connected to the first pins correspondingly.

In one embodiment of the present invention, the length of the alignment pins is shorter than that of the first pins.

In one embodiment of the present invention, the alignment pins are disposed on both sides of the first pins.

In one embodiment of the present invention, one of the alignment pins is disposed between the middle of all the first pins.

In one embodiment of the present invention, the materials of the first pins and the alignment pins are the same.

In one embodiment of the present invention, the floating pins are connected to the alignment pins correspondingly.

The present invention is directed to a method of fabricating a display panel that includes the following steps. First, a display panel divided into a display region and a non-display region is provided. Further, a plurality of pad regions is defined in the non-display region. Next, a plurality of first pins and a plurality of alignment pins are formed in each pad region. Thereafter, a plurality of chips is provided. Herein, each chip has a plurality of second pins and a plurality of floating pins. Further, the floating pins correspond to the locations of the alignment pins. Finally, the first pins are compressed to the corresponding second pins.

In one embodiment of the present invention, the step of forming the first pins and the alignment pins includes disposing the alignment pins on both sides of the first pins.

In one embodiment of the present invention, the step of forming the first pins and the alignment pins includes disposing one of the alignment pins between the middle of all the first pins.

In one embodiment of the present invention, the method for compressing the first pins to the corresponding second pins includes a thermal compression.

In one embodiment of the present invention, the step of compressing the first pins to the corresponding second pins further includes compressing the alignment pins to the corresponding floating pins.

In one embodiment of the present invention, after the step of compressing the first pins and the corresponding second pins, the alignment pins and the floating pins are used to inspect the misalignment of the first pins and the second pins.

In one embodiment of the present invention, the method used to inspect the misalignment of the first pins and the second pins includes visual inspection.

According to the present invention, an inspector can easily and conveniently determine whether the first pins and the second pins are aligned properly based on the alignment of the alignment pins and the floating pins. Hence, the inspector can easily monitor the fabrication yield of the display panel.

In order to make the aforementioned and other objects, features and advantages of the present invention more comprehensible, preferred embodiments accompanied with figures are described in detail below.

### BRIEF DESCRIPTION OF THE DRAWINGS

FIG. 1A is a schematic view illustrating a conventional display panel.

FIG. 1B is an enlarged partial view of FIG. 1A.

FIG. 2A is a schematic partial view illustrating a liquid crystal panel according to one embodiment of the present invention.

FIG. 2B is a schematic view illustrating the pad regions of the substrate shown in FIG. 2A.

FIG. 2C is a schematic view illustrating the bonding for the first pins of the substrate and the second pins of the chips.

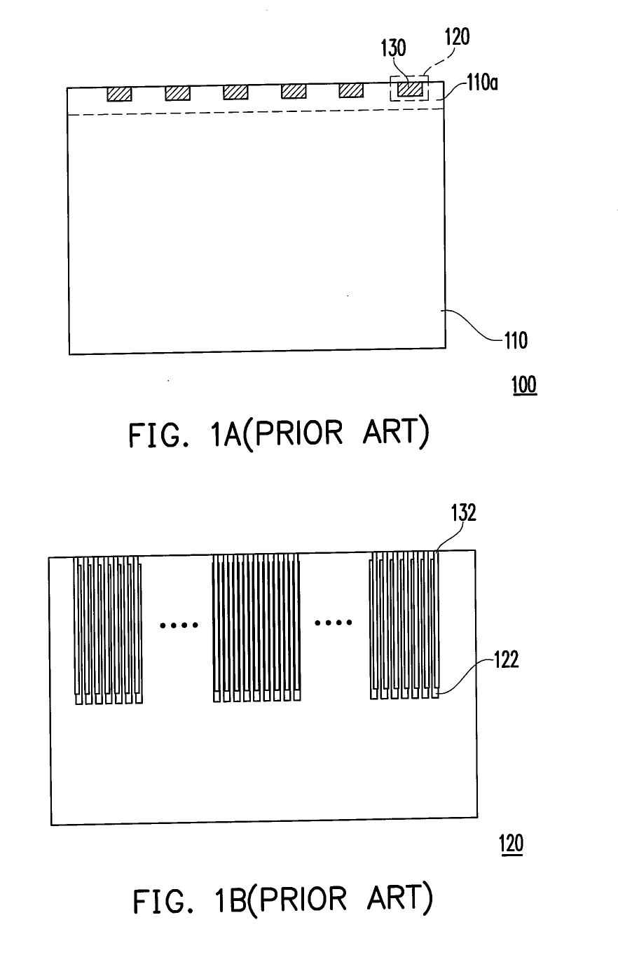

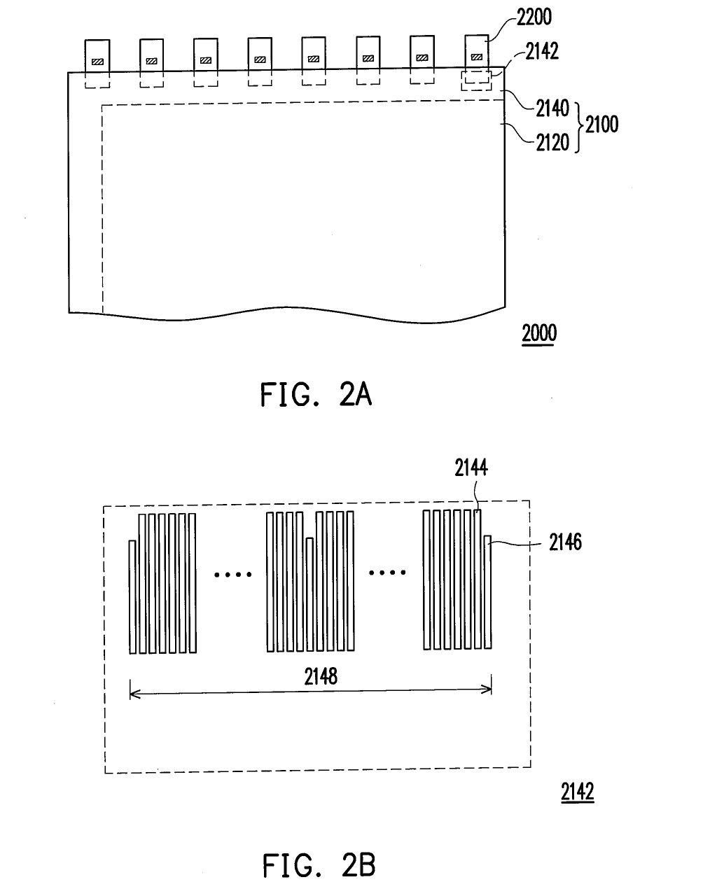

### DESCRIPTION OF EMBODIMENTS

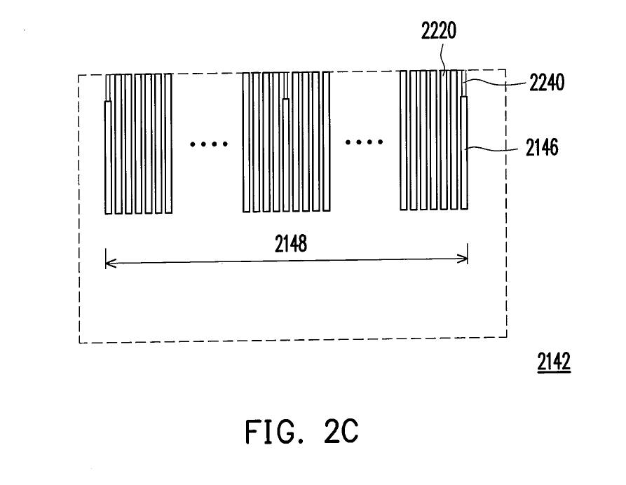

FIG. 2A is a schematic partial view illustrating a liquid crystal panel according to one embodiment of the present invention. Please refer to FIG. 2A. In the present embodiment, a display panel 2000 includes a substrate 2100 and a plurality of chips 2200. The substrate 2100 has a display region 2120 and a non-display region 2140 disposed on one side of the display region 2120. A plurality of pad regions 2142 is located in the non-display region 2140. Herein, each chip 2200 is disposed in one pad region 2142 correspondingly.

FIG. 2B is a schematic view illustrating the pad regions of the substrate shown in FIG. 2A and FIG. 2C is a schematic view illustrating the bonding for the first pins of the substrate and the second pins of the chips. Please refer to FIG. 2A, FIG. 2B, and FIG. 2C. A plurality of first pins 2144 and a plurality of alignment pins 2146 are disposed in each pad region 2142. Herein, the first pins 2144 are well-known as panel pins in the industry. It should be noted that, in the present embodiment, the length of the alignment pins 2146 is shorter than that of the first pins 2144 to distinguish between the alignment pin 2146 and the first pin 2144.

Further, to avoid complicating the fabrication process, the alignment pins 2146 and the first pins 2144 are fabricated using the same material and formed simultaneously on the substrate 2100 in the same fabricating step. In addition, the material used for fabricating the first pins 2144 and the alignment pins 2145 is an electrical conductor such as indium tin oxide (ITO).

In view of the above, each chip 2200 disposed in the pad region 2142 has a plurality of second pins 2220 and at least one floating region 2240. Herein, the floating pins 2240 are disposed correspondingly to the alignment pins 2146. The second pins 2220 are well-known as chip pins in the industry. When disposing the chips 2200 in the non-display region 2140, the first pins 2144 and the second pins 2220 are compressed, and the alignment pins 2146 and the floating pins 2240 are compressed to ensure the first pins 2144 and the second pins 2220 are completely bonded and the alignment pins 2146 and the floating pins 2240 are completely bonded, too.

In the present embodiment, the method used to compress the pins is a thermal compression. Further, when the first pins 2144 and the second pins 2220 completely bonded, it is known as fine pitch.

Nevertheless, during the process of compressing the first pins 2144 and the second pins 2220, the first pins 2144 and the second pins 2220 may misalign due to the expansion of the material used for fabricating the pins. More specifically, the closer the first pins 2144 and the second pins 2220 are to the center of the pad regions 2142, the better the bonding for the first pins 2144 and the second pins 2220. The closer the first pins 2144 and the second pins 2220 are to the two sides of the pad regions 2142, the more likely they are misaligned due to the characteristic of the material.

If the second pins 2220 fail to bond with the first pins 2144, the chips 2200 cannot function properly and the product yield of the display panel 2000 is lowered as well.

It should be noted that the alignment pins 2146 in the present embodiment can be used to inspect the bonding of the second pins 2220 and the first pins 2144, and the fabrication yield of the display panel 2000 can be instantly improved.

More specifically, in the display panel 2000 of the present embodiment, at least two alignment pins 2146 are respectively disposed on the two sides of the first pins 2144. Therefore, the bonding of the alignment pins 2146 and the floating pins 2240 are inspected to determine the well-bonding between the second pins 2220 of the chips 2200 and the first pins 2144 of the substrate 2100.

When the alignment pins 2146 disposed on the two sides of all the first pins 2144 are completely bonded with the floating pins 2240, it means the first pins 2144 in the pad regions 2142 are completely bonded with the second pins 2220. As shown in FIG. 2C, the second pins 2220 completely cover the first pins 2144. As a result, the fabrication yield of the display panel 2000 can be easily monitored by visual inspection.

Further, for the convenience of inspection, an alignment pin 2146 can be disposed between in the middle of all the first pins 2144. Alternatively, an alignment pin 2146 can be disposed between any two adjacent first pins 2144. The bonding yield of the display panel 2000 can be more precisely determined by inspecting the bonding between the alignment pins 2146 and the floating pins 2240.

Although the length of the first pins 2144 is shorter than that of the alignment pins 2146 in the present embodiment, the present invention is not limited thereto. Further, after reviewing the scope and/or embodiments of the present invention, any one skilled in the art can easily replace the shape of the alignment pins 2146 or use other calibration mark that are easy to recognize.

It should be noted that, the above-mentioned method of inspection defines a carrying region 2148 in the pad regions 2142 to improve the bonding rate among pins in the display panel 2000. Simply put, the carrying region 2148 refers to the region where the first pins 2144 and the second pins 2220 are completely bonded without misalignment. In the carrying region 2148, the first pins 2144 that are bonded to the second pins 2220 and have a precise fine pitch. Hence, pins can be correspondingly disposed only in the carrying region 2148 to save the manufacturing costs.

In summary, the liquid crystal panel and the fabrication method thereof according to the present invention have at least the following advantages:
1. Based on the bonding between the alignment pins and the floating pins, an inspector can easily recognize the bonding between pins. It is adapted to monitor the fabrication yield of the display panel.
2. Based on the bonding between the alignment pins and the floating pins, an inspector can easily determine whether there is any defect in a display panel, and therefore decide whether the display panel needs to be reworked. Then, inspection time and human resource can be saved, and the yield of the display panel is improved.
3. Based on the bonding between the alignment pins and the floating pins, a carrying region is defined in the pad region of the substrate, and the pins in this region are connected and have a precise fine pitch.
4. Defining a carrying region and disposing pins only in the carrying region to reduce the material costs of the pins.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display panel, comprising:
a substrate having a display region and a non-display region disposed on one side of the display region, wherein a plurality of pad regions is disposed in the non-display region, and a plurality of first pins and a plurality of alignment pins are disposed in each pad region; and
a plurality of chips disposed in the non-display region, wherein each chip has a plurality of second pins and a plurality of floating pins, and the second pins are connected to the first pins correspondingly while the floating pins are connected to the alignment pins correspondingly.

2. The display panel of claim 1, wherein the length of the alignment pins is shorter than the length of the first pins.

3. The display panel of claim 1, wherein the alignment pins are disposed on both sides of the first pins.

4. The display panel of claim 1, wherein one of the alignment pins is disposed between the middle of all the first pins.

5. The display panel of claim 1, wherein the materials of the first pins and the alignment pins are the same.

6. The display panel of claim 1, wherein the floating pins and the alignment pins are connected correspondingly.

7. A method of fabricating a display panel, comprising:
providing a display panel divided into a display region and a non-display region, wherein a plurality of pad regions is defined in the non-display region;
forming a plurality of first pins and a plurality of alignment pins in each pad region;
providing a plurality of chips, wherein each chip has a plurality of second pins and a plurality of floating pins, and the floating pins are connected to the alignment pins correspondingly; and
compressing the first pins to the corresponding second pins.

8. The method of claim 7, forming the first pins and the alignment pins includes disposing the alignment pins on both sides of all the first pins.

9. The method of claim 7, forming the first pins and the alignment pins includes disposing one of the alignment pins between in the middle of all the first pins.

10. The method of claim 7, wherein the method used for compressing the first pins to the corresponding second pins comprises a thermal compression.

11. The method of claim 7, further comprising compressing the alignment pins to the corresponding floating pins when compressing the first pins to the corresponding second pins.

12. The method of claim 7, further comprising inspecting the misalignment of the first pins and the second pins based on the alignment pins and the floating pins after the first pins and the corresponding second pins are compressed.

13. The method of claim 12, wherein the method used for inspecting the misalignment of the first pins and the second pins comprises visual inspection.
